(19) United States
(12) Patent Application Publication
(10) Pub. No.: US 2023/0151164 A1
(43) Pub. Date: May 18, 2023

(54) POLYETHYLENE FILM FOR HEAT SEALING

(71) Applicant: SABIC GLOBAL TECHNOLOGIES B.V., Bergen op Zoom (NL)

(72) Inventors: Ling FAN, Shanghai (CN); Lanya CHENG, Shanghai (CN); Qiang WANG, Shanghai (CN); Hongtao SHI, Shanghai (CN); Maria SOLIMAN, Selfkant (DE); Jun ZHOU, Shanghai (CN)

(21) Appl. No.: 17/917,698

(22) PCT Filed: Apr. 6, 2021
(86) PCT No.: PCT/EP2021/058935

§ 371 Date: Oct. 7, 2022

(30) Foreign Application Priority Data
Apr. 10, 2020 (CN) PCT/CN2020/084273
Apr. 28, 2020 (WO) 20171711.3

(51) Int. Cl. C08J 5/18; B32B 27/32; C08L 23/08

(52) U.S. Cl. CPC C08J 5/18; B32B 27/32; C08L 23/0815; B32B 2250/40; B32B 2270/00; B32B 2307/732; B32B 2307/31; B32B 2439/70; C08J 2323/08; C08J 2423/08; C08L 2203/162; C08L 2205/025

(57) ABSTRACT

A film includes a sealing layer containing a polyethylene A having moieties derived from ethylene and moieties derived from an α-olefin comprising 4 to 10 carbon atoms, the polyethylene A having a density of ≥870 and ≤920 kg/m³, wherein the polyethylene A has: a fraction of material that is eluted in analytical temperature rising elution fractionation (a-TREF) at a temperature ≤30.0° C. of ≥5.0 wt % and ≤15.0 wt %, with regard to the total weight of the polyethylene; and two distinct peaks in the a-TREF curve in the elution temperature range of between 50.0 and 90.0° C., wherein the elution temperature gap between the two peaks is ≤17.5° C. The film can be sealed at a desirably low temperature, whilst still having a desirable seal strength. Furthermore, the film demonstrates a desirably high heat stability.

### CROSS REFERENCE TO RELATED APPLICATIONS

This application is a National Stage application of PCT/EP2021/058935, filed Apr. 6, 2021, which claims the benefit of PCT Application PCT/CN2020/084273, filed Apr. 10, 2020, and European Application 20171711.3, filed Apr. 28, 2020, all of which are incorporated by reference in their entirety herein.

### FIELD

The present invention relates to a polyethylene film for heat sealing, and to multilayer structures comprising such film. The invention also relates to articles comprising such films, and to a process for the production of a sealed article comprising such films.

### BACKGROUND

Films comprising or consisting of polyethylene materials are abundantly used in a wide variety of applications. A particular example where such polyethylene films find their application is in food packaging. Use of polyethylenes allows for packaging of foodstuff products in a very hygienic manner, contributes to preservation of the packaged products for a prolonged period, and can be done in a very economically attractive way. Further, polyethylene films can be produced with a highly attractive appearance.

Polyethylene materials that are suitable for the production of films include low-density polyethylenes, also referred to as LDPE, high-density polyethylenes, also referred to as HDPE, and linear low-density polyethylenes, also referred to as LLDPE. Particularly suitable for many film applications are linear low-density polyethylenes.

Linear low-density polyethylenes may for example be polyethylenes comprising moieties derived from ethylene and moieties derived from an α-olefin comprising 4 to 10 carbon atoms, having a density of ≥870 and ≤920 kg/m³ as determined in accordance ASTM D792 (2013). Preferably, the polyethylene has a density of ≥880 and ≤915 kg/m³, more preferably of ≥890 and ≤910 kg/m³.

The LLDPE may for example have a melt mass-flow rate, determined at 190° C. under a load of 2.16 kg (MFR2), in accordance with ASTM D1238 (2013), of ≥0.01 and ≤10.00 g/10 min, preferably ≥0.10 and ≤5.00 g/10 min, more preferably ≥0.50 and ≤2.50 g/10 min. Such LLDPE allows for manufacturing of films with appropriate melt stability and processability.

In the field of application of polyethylene films for packaging, a particular aspect relates to the sealing of such packages.

In commercial use, polyethylene films may for example be used in packaging of products, such as foodstuffs, wherein the package is filled with the desired product and sealed by contacting two layers of film, such as a tubular film obtained by blown film extrusion, and application of heat to at least a portion of the area where the films are contacting each other. The applied heat results in a local softening of the polyethylene material of both the layers that are brought into contact with each other. This leads to adhesion between the two layers, and, upon cooling, to a closed seal, thus forming a package that contains the desired contents separated from the surrounding atmosphere.

Such packages are well known in everyday applications, and allow for example a significant increase in retention of the contained products.

In such packaging solutions, the seals that are produced using such heat-sealing technology as described above need to have a certain strength. This is required in order to be able to produce a package that, during production, transport and consumer use, is able to withstand certain forces it should be considered able to withstand. Therefore, the strength of the seal should be above a certain threshold.

What is further important, in view of the process efficiency of the packaging process as well as the energy consumption during the packaging process, is that such seal having a desirably high strength may be produced at a sealing temperature that is desirably low. The lower the temperature at which the seal is formed, the less energy is to be employed. A further benefit of a lower temperature that is required for seal formation is that the contents of the package are to a lesser degree subjected to certain elevated temperatures, which, for example in the case of packaging of foodstuffs, may be beneficial for the retention of the quality of the packaged contents.

A further important property in such packaging solutions based on polyethylene materials is the so-called hot tack strength. In the context of the present invention, the hot tack strength is to be understood as the strength of a seal made in a film of the polyethylene by heat-sealing immediately after the sealing, before the seal has cooled down. The hot tack strength affects the efficiency of the packaging process in which the polyethylene film material is employed, for example the speed at which the packaging lines may be operated. The higher the hot tack strength, the less cooling time is required upon seal formation prior to further processing of the package, i.e. the earlier the strength of the seal is of such magnitude as to be able to withstand exerted forces without damaging the seal, the shorter the cycle time in for example continuous packaging machines.

For these reasons, there is an ongoing desire in the packaging industry to have access to polyethylene films that demonstrate a reduction of the temperature at which a seal of certain defined strength can be produced, where the hot-tack strength of that seal is particularly high.

### SUMMARY

Such films are now provided according to the present invention by a film comprising a sealing layer comprising a polyethylene A comprising moieties derived from ethylene and moieties derived from an α-olefin comprising 4 to 10 carbon atoms, the polyethylene A having a density of ≥870 and ≤920 kg/m³, preferably of ≥900 and ≤920 kg/m³, as determined in accordance with ASTM D792 (2013), wherein the polyethylene A has:
a fraction of material that is eluted in analytical temperature rising elution fractionation (a-TREF) at a temperature ≤30.0° C. of ≥5.0 wt % and ≤15.0 wt %, preferably ≥7.5 wt % and ≤12.5 wt %, with regard to the total weight of the polyethylene; and
two distinct peaks in the a-TREF curve in the elution temperature range of between 50.0 and 90.0° C., wherein the elution temperature gap between the two peaks is ≤17.5° C., preferably ≤15.0° C.

Such film allows for sealing of the film at a desirably low temperature, whilst still providing a desirable seal strength. Furthermore, such films demonstrates a desirably high heat stability.

### DETAILED DESCRIPTION

The polyethylene A that is employed in the sealing layer of the film according to the present invention has a density of ≥870 and ≤920 kg/m³, preferably of ≥880 and ≤915 kg/m³, more preferably of ≥890 and ≤910 kg/m³, even more preferably of ≥895 and ≤905 kg/m³, or of ≥900 and ≤920 kg/m³, preferably of ≥900 and ≤915 kg/m³, more preferably of ≥900 and ≤910 kg/m³, or even more preferably of ≥900 and ≤905 kg/m³. The use of a polyethylene having such density in the sealing layer of the film according to the invention contributes to improved sealing.

The polyethylene A preferably demonstrates an elution temperature gap of ≥5.0 and ≤15.0° C. between its two distinct peaks in the a-TREF curve in the temperature range of between 50.0 and 90.0° C., also referred to in this application as the peak gap. Preferably, the peak gap is ≥10.0 and ≤15.0° C.

According to the invention, analytical temperature rising elution fractionation, also referred to as a-TREF, may be carried out using a Polymer Char Crystaf-TREF 300 equipped with stainless steel columns having a length of 15 cm and an internal diameter of 7.8 mm, with a solution containing 4 mg/ml of sample prepared in 1,2-dichlorobenzene stabilised with 1 g/l Topanol CA (1,1,3-tri(3-tert-butyl-4-hydroxy-6-methylphenyl)butane) and 1 g/l Irgafos 168 (tri(2,4-di-tert-butylphenyl) phosphite) at a temperature of 150° C. for 1 hour. The solution may be further stabilised for 45 minutes at 95° C. under continuous stirring at 200 rpm before analyses. For analyses, the solution was crystallised from 95° C. to 30° C. using a cooling rate of 0.1° C./min. Elution may be performed with a heating rate of 1° C./min from 30° C. to 140° C. The set-up may be cleaned at 150° C. The sample injection volume may be 300 μl, and the pump flow rate during elution 0.5 ml/min. The volume between the column and the detector may be 313 μl. The fraction that is eluted at a temperature of ≤30.0° C. may in the context of the present invention be calculated by subtracting the sum of the fraction eluted >30.0° C. from 100%, thus the total of the fraction eluted ≤30.0° C., and the fraction eluted >30.0° C. to add up to 100.0 wt %.

Particularly, a-TREF may be carried out using a Polymer Char Crystaf-TREF 300 using a solution containing 4 mg/ml of the polymer in 1,2-dichlorobenzene, wherein the solution is stabilised with 1 g/l 1,1,3-tri(3-tert-butyl-4-hydroxy-6-methylphenyl)butane and 1 g/l tri(2,4-di-tert-butylphenyl) phosphite) at a temperature of 150° C. for 1 hour, and further stabilised for 45 minutes at 95° C. under continuous stirring at 200 rpm, wherein the prior to analyses the solution is crystallised from 95° C. to 30° C. using a cooling rate of 0.1° C./min, and elution is performed at a heating rate of 1° C./min from 30° C. to 140° C., and wherein the equipment has been cleaned at 150° C.

It is preferred that the in the polyethylene A as comprised in the sealing layer of the film of the present invention, the ratio q₂/q₁ of the elution quantity of the polyethylene A in a-TREF at the maximum of the peak P2 in the elution curve in the elution temperature interval of between 50.0 and 90.0° C. that occurs at the highest temperature (q₂) to the elution quantity at the maximum of the peak P1 in the interval of between 50.0 and 90.0° C. that occurs at the lowest temperature (q₁) is ≥1.40, preferably ≥0.75 and ≤1.25, even more preferably ≥1.05 and ≤1.20, the elution quantity being a weight quantity.

In the polyethylene A, it is preferred that, by determination of the composition of the polyethylene A via a-TREF, the difference Δρ in the density ρ₂ of the polymer material that is eluted at P2 and the density ρ₁ of the polymer material that is eluted at P1 (Δρ=ρ₂−ρ₁) is ≥15 kg/m³, preferably ≥10 and ≤15 kg/m³.

The polyethylene A that is employed in the sealing layer of the film according to the present invention preferably has a melt mass-flow rate, determined at 190° C. under a load of 2.16 kg (MFR2), in accordance with ASTM D1238 (2013), of ≥0.01 and ≤10.00 g/10 min, more preferably ≥0.10 and ≤5.00 g/10 min, even more preferably ≥0.50 and ≤2.50 g/10 min, yet even more preferably ≥0.50 and ≤1.50 g/10 min. Such polyethylene allows for manufacturing of films with appropriate melt stability and processability.

It is preferred that the polyethylene A comprises ≥70.0 wt % of moieties derived from ethylene, with regard to the total weight of the polyethylene, preferably ≥75.0 wt %, more preferably ≥80.0 wt %. Preferably, the polyethylene A comprises ≥70.0 and ≤98.0 wt %, more preferably ≥75.0 and ≤95.0 wt %, even more preferably ≥80.0 and ≤90.0 wt % of moieties derived from ethylene, with regard to the total weight of the polyethylene.

It is further preferred that the polyethylene A comprises ≤30.0 wt % of moieties derived from an α-olefin comprising 4-10 carbon atoms, with regard to the total weight of the polyethylene, preferably ≤25.0 wt %, more preferably ≤20.0 wt %. The polyethylene A may for example comprise ≥5.0 wt % of moieties derived from an α-olefin comprising 4-10 carbon atoms, with regard to the total weight of the polyethylene, preferably ≥10.0 wt %, more preferably ≥15.0 wt %. For example, the polyethylene A may comprise ≥5.0 and ≤30.0 wt % of moieties derived from an α-olefin comprising 4-10 carbon atoms, with regard to the total weight of the polyethylene, preferably ≥15.0 wt % and ≤30.0 wt %, more preferably ≥15.0 and ≤20.0 wt %.

The α-olefin may comprising 4-10 carbon atoms for example be selected from 1-butene, 1-hexene, 4-methyl-1-pentene, and 1-octene, such as from 1-butene, 1-hexene and 1-octene. For example, the α-olefin comprising 4-10 carbon atoms may be selected from 1-hexene and 1-octene. The moieties derived from an α-olefin comprising 4-10 carbon atoms may for example be moieties derived from 1-butene, 1-hexene, 4-methyl-1-pentene, 1-octene, or combinations thereof, preferably from 1-hexene or 1-octene.

The polyethylene A that is employed in the sealing layer of the film according to the present invention may for example comprise ≤30.0 wt % of moieties derived from an α-olefin comprising 4-10 carbon atoms, with regard to the total weight of the polyethylene, preferably ≤25.0 wt %, more preferably ≤20.0 wt %, wherein the α-olefin comprising 4-10 carbon atoms is selected from 1-butene, 1-hexene, 4-methyl-1-pentene, and 1-octene, such as from 1-butene, 1-hexene and 1-octene. The polyethylene A may for example comprise ≥5.0 wt % of moieties derived from an α-olefin comprising 4-10 carbon atoms, with regard to the total weight of the polyethylene, preferably ≥10.0 wt %, more preferably ≥15.0 wt %, wherein the α-olefin comprising 4-10 carbon atoms is selected from 1-butene, 1-hexene, 4-methyl-1-pentene, and 1-octene, such as from 1-butene, 1-hexene and 1-octene. For example, the polyethylene A may comprise ≥5.0 and ≤30.0 wt % of moieties derived from an α-olefin comprising 4-10 carbon atoms, with regard to the total weight of the polyethylene, preferably ≥10.0 wt % and ≤25.0 wt %, more preferably ≥15.0 and ≤20.0 wt %, wherein the α-olefin comprising 4-10 carbon atoms is selected from 1-butene, 1-hexene, 4-methyl-1-pentene, and 1-octene, such as from 1-butene, 1-hexene and 1-octene. For example, the polyethylene A may comprise ≥5.0 and ≤30.0 wt % of moieties derived from an α-olefin comprising 4-10 carbon atoms, with regard to the total weight of the polyethylene, preferably ≥10.0 wt % and ≤25.0 wt %, more preferably ≥15.0 and ≤20.0 wt %, wherein the α-olefin comprising 4-10 carbon atoms is 1-octene.

The content of moieties derived from the α-olefin and the type of α-olefin may be determined by ¹³C NMR on a Bruker Avance 500 spectrometer equipped with a cryogenically cooled probe head operating at 125° C., whereby the samples are dissolved at 130° C. in C₂D₂Cl₄ containing DBPC as stabiliser.

Preferably, the polyethylene A has a fraction of material that is eluted in a-TREF in the elution temperature range of ≥90° C. of ≤5.0 wt %, more preferably ≤2.0 wt %. Even more preferably, the polyethylene A is substantially free of material that is eluted in a-TREF in the temperature range of ≥90° C.

The polyethylene A may for example have a weight-average molecular weight (M_{w}) of ≥75,000 and ≤150,000 g/mol, preferably of ≥100,000 and ≤125,000 g/mol. The polyethylene A may for example have a number-average molecular weight (Mₙ) of ≥20,000 and ≤50,000 g/mol, preferably of ≥25,000 and ≤40,000 g/mol. The polyethylene A may for example have a z-average molecular weight (M_{z}) of ≥200,000 and ≤400,000 g/mol, preferably of ≥250,000 and ≤350,000 g/mol. The polyethylene A may for example have a molecular weight distribution M_{w}/Mₙ of ≥2.0 and ≤4.0, preferably of ≥2.5 and ≤3.5. In the context of the present invention, the M_{w}, the Mₙ and the M_{z} may be determined in accordance with ASTM D6474 (2012).

Preferably, the sealing layer comprises ≥10.0 wt % and ≤90.0 wt % of the polyethylene A, with regard to the total weight of the sealing layer, more preferably ≥15.0 and ≤85.0 wt %, even more preferably ≥25.0 wt % and ≤75.0 wt %, yet even more preferably ≥30.0 wt % and ≤70.0 wt %, yet even further preferably ≥50.0 wt % and ≤70.0 wt %.

The sealing layer may further comprise a quantity of a polyethylene B, for example ≥10.0 wt % and ≤70.0 wt %, preferably ≥20.0 and ≤50.0 wt %, of a polyethylene B, with regard to the total weight of the sealing layer, preferably of wherein the polyethylene B is a copolymer comprising moieties of ethylene and moieties derived from 1-butene, 1-hexene or 1-octene. Preferably, the polyethylene B is a copolymer comprising moieties derived from ethylene and moieties derived from 1-butene.

For example, the polyethylene B may have a density of ≥905 and ≤935 kg/m³, preferably of ≥910 and ≤930 kg/m³, more preferably of ≥915 and ≤925 kg/m³.

The polyethylene B may for example have a melt mass-flow rate (MRF2) of ≥0.1 and ≤5.0, preferably ≥0.2 and ≤4.0, more preferably ≥0.5 and ≤3.0, even more preferably ≥0.5 and ≤2.0 g/10 min.

Preferably, the polyethylene B and the polyethylene A are different.

In a certain embodiment of the invention, it also relates to a film comprising a sealing layer comprising or consisting essentially of:
(i) a polyethylene A comprising moieties derived from ethylene and moieties derived from 1-octene, the polyethylene A having a density of ≥870 and ≤920 kg/m³, preferably of ≥900 and ≤920 kg/m³, as determined in accordance with ASTM D792 (2013), wherein the polyethylene A has:
   a fraction of material that is eluted in analytical temperature rising elution fractionation (a-TREF) at a temperature ≤30.0° C. of ≥5.0 wt % and ≤15.0 wt %, preferably ≥7.5 wt % and ≤12.5 wt %, with regard to the total weight of the polyethylene; and
   two distinct peaks in the a-TREF curve in the elution temperature range of between 50.0 and 90.0° C., wherein the elution temperature gap between the two peaks is ≤17.5° C., preferably ≤15.0° C.;

and
(ii) a polyethylene B being a copolymer comprising moieties of ethylene and moieties derived from 1-butene or 1-hexene, having a density of ≥910 and ≤930 kg/m³.

In a particular embodiment, the invention also relates to a film comprising a sealing layer comprising or consisting essentially of:
(i) ≥10.0 and ≤90.0 wt %, preferably ≥30.0 and ≤70.0 wt %, with regard to the total weight of the sealing layer, of a polyethylene A comprising moieties derived from ethylene and moieties derived from 1-octene, the polyethylene A having a density of ≥870 and ≤920 kg/m³, preferably of ≥900 and ≤920 kg/m³, as determined in accordance with ASTM D792 (2013), wherein the polyethylene A has:
   a fraction of material that is eluted in analytical temperature rising elution fractionation (a-TREF) at a temperature ≤30.0° C. of ≥5.0 wt % and ≤15.0 wt %, preferably ≥7.5 wt % and ≤12.5 wt %, with regard to the total weight of the polyethylene; and
   two distinct peaks in the a-TREF curve in the elution temperature range of between 50.0 and 90.0° C., wherein the elution temperature gap between the two peaks is ≤17.5° C., preferably ≤15.0° C.;

and
(ii) ≥10.0 and ≤70.0 wt %, preferably ≥20.0 and ≤50.0 wt %, with regard to the total weight of the sealing layer, a polyethylene B being a copolymer comprising moieties of ethylene and moieties derived from 1-butene or 1-hexene, having a density of ≥910 and ≤930 kg/m³.

In certain of its embodiments, the invention also relates to an embodiment wherein the film may further comprise in the sealing layer a polyethylene C. It is preferred that the polyethylene C differs from each of polyethylene A and polyethylene B.

The polyethylene C may preferably be a low-density polyethylene (LDPE). For example, the polyethylene C may be an LDPE having a density of ≥910 and ≤930 kg/m³, preferably of ≥915 and ≤925 kg/m³. For example, the polyethylene C may be an LDPE having an MFR2 of ≥0.5 and ≤10.0 g/10 min, preferably ≥0.5 and ≤5.0 g/10 min, more preferably ≥1.0 and ≤3.0 g/10 min.

The sealing layer may for example comprise ≥5.0 and ≤50.0 wt % of the polyethylene C, preferably ≥10.0 and ≤30.0 wt %, with regard to the total weight of the sealing layer.

It is preferred that the polyethylene C is an LDPE homopolymer.

A particularly preferred embodiment of the invention relates to a film comprising a sealing layer comprising or consisting essentially of:
(i) a polyethylene A comprising moieties derived from ethylene and moieties derived from 1-octene, the polyethylene A having a density of ≥870 and ≤920 kg/m³, preferably of ≥900 and ≤920 kg/m³, as determined in accordance with ASTM D792 (2013), wherein the polyethylene A has:
   a fraction of material that is eluted in analytical temperature rising elution fractionation (a-TREF) at a temperature ≤30.0° C. of ≥5.0 wt % and ≤15.0 wt %, preferably ≥7.5 wt % and ≤12.5 wt %, with regard to the total weight of the polyethylene; and
   two distinct peaks in the a-TREF curve in the elution temperature range of between 50.0 and 90.0° C., wherein the elution temperature gap between the two peaks is ≤17.5° C., preferably ≤15.0° C.;
(ii) a polyethylene B being a copolymer comprising moieties of ethylene and moieties derived from 1-butene or 1-hexene, having a density of ≥910 and ≤930 kg/m³; and
(iii) a polyethylene C being a low-density polyethylene homopolymer having a density of ≥910 and ≤930 kg/m³.

Particularly, the invention relates to a film comprising a sealing layer comprising or consisting essentially of:
(i) ≥10.0 and ≤90.0 wt %, preferably ≥30.0 and ≤70.0 wt %, with regard to the total weight of the sealing layer, of a polyethylene A comprising moieties derived from ethylene and moieties derived from 1-octene, the polyethylene A having a density of ≥870 and ≤920 kg/m³, preferably of ≥900 and ≤920 kg/m³, as determined in accordance with ASTM D792 (2013), wherein the polyethylene A has:
   a fraction of material that is eluted in analytical temperature rising elution fractionation (a-TREF) at a temperature ≤30.0° C. of ≥5.0 wt % and ≤15.0 wt %, preferably ≥7.5 wt % and ≤12.5 wt %, with regard to the total weight of the polyethylene; and
   two distinct peaks in the a-TREF curve in the elution temperature range of between 50.0 and 90.0° C., wherein the elution temperature gap between the two peaks is ≤17.5° C., preferably ≤15.0° C.;
(ii) ≥10.0 and ≤70.0 wt %, preferably ≥20.0 and ≤50.0 wt %, with regard to the total weight of the sealing layer, a polyethylene B being a copolymer comprising moieties of ethylene and moieties derived from 1-butene or 1-hexene, having a density of ≥910 and ≤930 kg/m³; and
(iii) ≥10.0 and ≤30.0 wt %, with regard to the total weight of the sealing layer, of a polyethylene C being a low-density polyethylene homopolymer having a density of ≥910 and ≤930 kg/m³.

In the context of the present invention, the embodiment wherein the sealing layer of the film essentially consists of the polyethylene A, the polyethylene B and/or the polyethylene C, is to be understood as wherein the layer A of the film consists of the polyethylene and additives known in the art of polyethylene films, such as up to 1.0 wt % of additives, with regard to the total weight of the film. Suitable additives may for example include UV stabilisers, antioxidants, and processing aids.

The sealing layer may for example have a thickness of 1-100 μm, preferably 5-50 μm, more preferably 5-25 μm, more preferably 5-15 μm.

In one of its embodiments, the film consists of the sealing layer.

The polyethylene may for example be produced via a solution polymerisation process, preferably by polymerisation of ethylene with 1-hexene and/or 1-octene. The polyethylene may for example be produced using a metallocene-type catalyst, preferably by polymerisation of ethylene with 1-hexene and/or 1-octene.

In certain of its embodiments, the present invention also relates to certain multilayer film structures comprising a film according to the present invention. For example, the invention also relates to a multilayer film structure comprising a film according to the present invention, wherein the film is positioned such in the arrangement of the multilayer film structure that at least one of the outer surfaces of the multilayer film structure is constituted by the sealing layer. Alternatively, the invention also relates to a multilayer film structure comprising a film according to the present invention, wherein the film is positioned such in the arrangement of the multilayer film structure that both the outer surfaces of the multilayer film structure are constituted by the sealing layer.

In a further embodiment, the invention relates to a multilayer film structure comprising two outer layers and at least one inner layer positioned between the two outer layers, wherein one of the outer layers is constituted by the sealing layer or wherein both outer layers are each constituted by the sealing layer.

The multilayer film structure may for example comprises 3-15 layers, preferably 3-11 layers, more preferably 3-7 layers. The multilayer film structure may for example comprise 3 layers, or 5 layers, or 7 layers.

The multilayer film structure may for example have a thickness of 2-150 μm, preferably 20-100 μm, more preferably 25-75 μm.

In a particular embodiment, the invention also relates to a process for preparing an article comprising a sealed film, the process comprising the steps in this order of:
providing a film or a multilayer film structure according to the invention;
providing an object comprising a surface for sealing with the film or the multilayer film structure;
arranging the film or multilayer film structure and the object so that a layer A of the film or the multilayer film structure and the surface for sealing of the object can be brought into contact with each other;
contacting the film and the surface for sealing at a temperature of ≥60 and ≤80° C., during a time of 1-5 seconds, under application of a pressure of ≥0.3 N/mm² to obtain a heat-sealed article.

The invention also relates to an article comprising a film sealed to a surface, wherein the article comprises a film or a multilayer film structure according to the invention, or wherein the article is produced according to the process according to the invention. For example, such article may be a package for containing foodstuffs, or a package containing foodstuffs.

The invention will now be illustrated by the following non-limiting examples.

In the experiments conducted in the course of the present invention, the following polyethylene materials were used.

| | |
|---|---|
| PE1 | An ethylene-octene copolymer having its characteristics as |
| | described below, and comprising 19.8 wt % of 1-octene |
| PE2 | An ethylene-octene copolymer having its characteristics as |
| | described below, and comprising 19.1 wt % 1-octene |
| PE3 | SABIC ® LLDPE 118NE, an ethylene-butene copolymer |
| | obtainable from SABIC, having an MFR2 of 1.0 g/10 min and a |
| | density of 918 kg/m³ |
| PE4 | SABIC ® LDPE HP2023NN, a low-density polyethylene |
| | obtainable from SABIC, having an MFR2 of 2.0 g/10 min and a |
| | density of 923 kg/m³ |

The materials PE1 and PE2 were analysed to demonstrate the following product properties:

| | PE1 | PE2 |
|---|---|---|
| MFR2 (g/10 min) | 1.0 | 1.0 |
| Density (kg/m³) | 900 | 900 |
| Fraction a-TREF ≤30° C. (wt %) | 10.8 | 15.4 |
| P1 (° C.) | 62.5 | 59.1 |
| P2 (° C.) | 75.1 | 79.3 |
| Peak gap (° C.) | 12.6 | 20.2 |
| q₁ | 0.0618 | 0.0459 |
| q₂ | 0.0686 | 0.0739 |
| q₂/q₁ | 1.11 | 1.61 |
| ρ₁ (kg/m³) | 896 | 892 |
| ρ₂ (kg/m³) | 908 | 911 |
| Δρ (kg/m³) | 12 | 19 |

Wherein:
The MFR2 is the melt mass-flow rate, determined at 190° C. under a load of 2.16 kg, in accordance with ASTM D1238 (2013);
The density is determined in accordance with ASTM D792 (2013)
The fraction a-TREF ≤30° C. is the fraction eluted in an a-TREF analysis conducted as described above below 30° C.;
P1 is the temperature at which the first peak, i.e. the peak eluting at the lowest temperature, in the elution interval between 50.0 and 90.0° C., occurs in the a-TREF analysis;
P1 is the temperature at which the second peak, i.e. the peak eluting at the highest temperature, in the elution interval between 50.0 and 90.0° C., occurs in the a-TREF analysis;
The peak gap is the elution temperature gap between the two peaks P2 and P1 (P2−P1);
q₁ is the elution quantity as weight fraction with regard to the total eluted quantity that is eluted at the temperature P1;
q₂ is the elution quantity as weight fraction with regard to the total eluted quantity that is eluted at the temperature P2;
ρ₁ is the density of the polymer material that is eluted in a-TREF analysis at the temperature P1;
ρ₂ is the density of the polymer material that is eluted in a-TREF analysis at the temperature P2;
Δρ is the difference ρ₂−ρ₁ of the densities of the polymer material eluted at the peak temperatures P1 and P2.

Using these materials, two different types of blown films were produced using a Labtech LF400-COEX machine with a 25 mm screw diameter, L/D ratio of 30. The films were prepared at 190° C., with a blow-up ratio of 2.5, a die gap of 2 mm, a frost line height of 16 cm, operated at 8 kg/h output. The films of the examples of the invention 1 and comparative 5 had a thickness of 30 μm. The film of example 1 consisted of the PE1, the film of example 5 consisted of PE2.

In the examples 2-4 of the invention and comparative 6-8, films had a thickness of 50 μm, and comprised a first layer having a thickness of 37.5 μm, comprising 75.0 wt % of PE3 and 25.0 wt % of PE4 and a second sealing layer having a thickness of 12.5 μm. In the table below, the compositions of each of the second film layer as used in the various experiments to demonstrate the invention are presented.

| Example | Second (sealing) layer composition |
|---|---|
| 2 | 20.0 wt % PE4, 60.0 wt % PE3, 20.0 wt % PE1 |
| 3 | 20.0 wt % PE4, 40.0 wt % PE3, 40.0 wt % PE1 |
| 4 | 20.0 wt % PE4, 20.0 wt % PE3, 60.0 wt % PE1 |
| 6 (C) | 20.0 wt % PE4, 60.0 wt % PE3, 20.0 wt % PE2 |
| 7 (C) | 20.0 wt % PE4, 40.0 wt % PE3, 40.0 wt % PE2 |
| 8 (C) | 20.0 wt % PE4, 20.0 wt % PE3, 60.0 wt % PE2 |

The films of the examples 1-8 produced as per the above formulation and process were subjected to analysis and testing, as described below. Of each of the films, the seal strength at given temperature is determined in accordance with ASTM F88 (2015) on a seal produced at the given temperature, expressed in N, on a seal of 15 mm width.

| Example | 2 | 3 | 4 | 6 | 7 | 8 |
|---|---|---|---|---|---|---|
| Seal strength @80° C. | 0.2 | 0.3 | 1.3 | 0.0 | 0.0 | 0.0 |
| Seal strength @85° C. | 0.3 | 0.6 | 8.0 | 0.0 | 0.0 | 0.0 |
| Seal strength @90° C. | 0.4 | 2.1 | 9.0 | 0.2 | 0.2 | 0.6 |
| Seal strength @95° C. | 0.6 | 9.3 | 9.8 | 0.2 | 0.4 | 7.0 |
| Seal strength @100° C. | 2.0 | 10.0 | 10.4 | 1.2 | 7.2 | 9.2 |
| Seal strength @105° C. | 10.0 | 10.8 | 11.8 | 6.0 | 9.6 | 9.6 |
| Seal strength @110° C. | 10.6 | 11.4 | 12.2 | 9.8 | 10.4 | 10.4 |
| Seal strength @120° C. | 13.2 | 13.4 | 13.0 | 12.2 | 12.4 | 12.6 |
| Seal strength @130° C. | 14.3 | 14.4 | 14.0 | 13.6 | 14.2 | 13.2 |

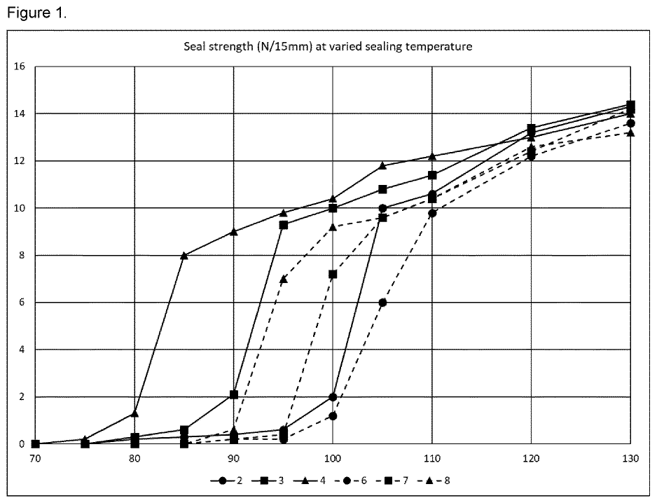

FIG. 1 presents a graph showing the curves of seal strength versus sealing temperature for the experimental films.

From the above results, it can be observed that the film of the present invention allows for the production of a seal by heat-sealing having a certain improved strength at a particularly low sealing temperature.

In order to assess the retention of seal strength of the film after being subjected to certain thermal exposure, the films of example 1 and 5 were subjected to a heat ageing process wherein the film was conditioned at 45° C. for 24 hours at 25% RH. Subsequently, the seal strength at various sealing temperatures was determined according to the method indicated above. The results thereof are presented in the table below.

| Experiment | 1A | 1B | 2A | 2B |
|---|---|---|---|---|
| Seal strength @80° C. | 3.8 | 3.8 | 3.9 | 3.1 |
| Seal strength @90° C. | 5.3 | 5.2 | 4.8 | 4.5 |
| Seal strength @100° C. | 6.5 | 6.5 | 6.1 | 5.7 |
| Seal strength @110° C. | 6.6 | 6.8 | 6.6 | 6.1 |

In this table, the experiment 1A shows the sealing strength data of a film of example 1 not subjected to the ageing process, and 1B for a film of example 1 after being subjected to the heat ageing process. As can be observed, the strength of the seals of the films of example 1 do not differ regardless of whether they were produced using an aged or non-aged sample; in the case of the films of example 2, one can clearly observe a deterioration of the seal strength.

1. A film comprising a sealing layer comprising a polyethylene A comprising moieties derived from ethylene and moieties derived from an α-olefin comprising 4 to 10 carbon atoms, the polyethylene A having a density of ≥870 and ≤920 kg/m³, as determined in accordance with ASTM D792 (2013),
wherein the polyethylene A has:
a fraction of material that is eluted in analytical temperature rising elution fractionation (a-TREF) at a temperature ≤30.0° C. of ≥5.0 wt % and ≤15.0 wt %, with regard to the total weight of the polyethylene; and
two distinct peaks in an a-TREF curve in an elution temperature range of between 50.0 and 90.0° C., wherein an elution temperature gap between the two peaks is ≤17.5° C.

2. The film according to claim 1, wherein a ratio q₂/q₁ of an elution quantity of the polyethylene A in a-TREF at the maximum of the peak P2 in the elution curve in the elution temperature interval of between 50.0 and 90.0° C. that occurs at the highest temperature (q₂) to the elution quantity at the maximum of the peak P1 in the interval of between 50.0 and 90.0° C. that occurs at the lowest temperature (q₁) is ≤1.40, the elution quantity being a weight quantity.

3. The film according to claim 1, wherein the polyethylene A has a fraction of material that is eluted in a-TREF in the elution temperature range of ≥90° C. of ≤5.0 wt %.

4. The film according to claim 1, wherein the sealing layer comprises ≥10.0 wt % and ≤90.0 wt % of the polyethylene A, with regard to the total weight of the sealing layer.

5. The film according to claim 1, wherein the sealing layer comprises ≥10.0 wt % and ≤70.0 wt % of a polyethylene B, with regard to the total weight of the sealing layer, wherein the polyethylene B is a copolymer comprising moieties of ethylene and moieties derived from 1-butene, 1-hexene or 1-octene.

6. The film according to claim 1, wherein, by determination of the composition of the polyethylene A via a-TREF, a difference Δρ in a density ρ₂ of the polymer material that is eluted at P2 and a density ρ₁ of the polymer material that is eluted at P1 (Δρ=ρ₂−ρ₁) is ≤15 kg/m³.

7. The film according to claim 1, wherein the α-olefin comprising 4 to 10 carbon atoms is 1-octene.

8. The film according to claim 1, wherein the polyethylene A comprises ≥15.0 and ≤30.0 wt % of moieties derived from 1-octene.

9. The film according to claim 1, wherein the polyethylene A comprises ≥70.0 wt % of moieties derived from ethylene, with regard to the total weight of the polyethylene.

10. The film according to claim 1, wherein the polyethylene A is produced via a solution polymerisation process, and/or wherein the polyethylene A is produced using a metallocene-type catalyst.

11. The film according to claim 1, wherein the sealing layer has a thickness of 1-100 μm.

12. The film according to claim 1, wherein the film consists of the sealing layer.

13. A multilayer film structure comprising a film according to claim 1, wherein the film is positioned in such an arrangement of the multilayer film structure that one or both of the outer surfaces of the multilayer film structure is constituted by the sealing layer.

14. The multilayer film structure according to claim 13 comprising two outer layers and at least one inner layer positioned between the two outer layers, wherein one of the outer layers is constituted by the sealing layer or wherein both outer layers are each constituted by the sealing layer.

15. The multilayer film structure according to claim 13, wherein the structure comprises 3-15 layers.

16. The multilayer film structure according to claim 13, wherein the structure has a thickness of 2-150 μm.
